(19) United States
(12) Patent Application Publication
(10) Pub. No.: US 2026/0336173 A1
(43) Pub. Date: Oct. 29, 2026

(54) INJECTION MOLD

(71) Applicant: Otto Männer GmbH, Bahlingen a.K. (DE)

(72) Inventors: Simon WURZBACHER, Dusseldorf (DE); Alexander GEHRING, Bötzingen (DE); Christian ESTORER, Bahlingen a. K. (DE); Lukas BOHNENBERGER, Teningen (DE)

(21) Appl. No.: 19/155,435

(22) PCT Filed: Feb. 13, 2024
(86) PCT No.: PCT/EP2024/053625

§ 371 Date: Aug. 11, 2025

(30) Foreign Application Priority Data
Feb. 15, 2023 (DE) 10 2023 103 666.1

(51) Int. Cl. B29C 45/28

(52) U.S. Cl. CPC B29C 45/281; B29C 2045/2865

(57) ABSTRACT

The present disclosure relates to an injection mold (1) comprising a first mold half (2) and a second mold half (3), wherein the first mold half (2) comprises at least one hot runner nozzle (4) with a needle (5) and an actuator (6) for actuating the needle (5) in the hot runner nozzle (4) in axial direction (x) of the needle (5) between a closed position and an open position. The needle (5) comprises a front section (8) and a rear section (9) interconnected to each other by a load cell (10) for transmitting force between the front section (8) and the rear section (9). The load cell (10) comprises a transducer (11) to determine during operation the force transmitted in axial direction (x) between the front section (8) and the rear section (9).

### FIELD OF THE DISCLOSURE

The present disclosure relates to an injection mold comprising at least one hot runner nozzle with a needle with a load cell, to determine forces acting upon the needle.

### BACKGROUND OF THE DISCLOSURE

EP1171275 published on behalf of DYNISCO HOTRUNNERS INC. on 16.01.2022 relates to an injection molding apparatus and system in which the rate of material flow during the injection cycle is controlled. An injection molding system is provided that includes an injection molding machine including a hydraulic power source, a manifold for distributing material injected from said injection molding machine to a plurality of gates leading to one or more mold cavities, and a controller to individually control respective rates at which material is injected through said gates during an injection cycle. The controller is coupled to the hydraulic power source and the hydraulic power source supplies hydraulic power to both, the injection molding machine and to control said respective rates.

JP12943793 published on behalf of MITSUBISHI GAS CHEMICAL CO on 22.04.2022 relates to a device with cavities in a pressure setting device in a comparison and computation device and compared with resin pressure sensed by a pressure sensor. When the pressure reaches the set pressure, a closing signal for a valve pin is issued from a controller, and a solenoid valve of a hydraulic pressure selector valve set on a hydraulic circuit of a hydraulic cylinder for actuating the valve pin is actuated to changeover the hydraulic circuit. A piston of the hydraulic cylinder is pushed down following the changeover of the circuit, and then the valve pin is pushed into the direction of a movable side template to seal a resin gate. Respective valve pins of the cavities reaching the set pressure are successively actuated one by one by the above-said operation to seal the gate. The unevenness of filling quantity among the cavities is eliminated by the arrangement.

### SUMMARY OF THE DISCLOSURE

Injection molds comprising sensors and load cells for monitoring operating parameters and forces within injection molds are known. Nevertheless, known mold assemblies usually either comprise sensors arranged within a cavity plate close to or even facing the cavity or alternatively load cells, which are typically arranged on the outside of the mold, e.g. behind the mold plates with respect to the cavity or even behind an actuator.

Arranging sensors within the cavity plate or facing the cavity has disadvantages. Adding a sensor to the cavity leads to substantial modifications of the cavity plate. Additionally, in case that the sensor needs to be replaced, usually the entire injection mold has to be disassembled. Typically, either at least the needle has to be extracted from the hot runner nozzle or even the hot runner nozzle as a whole has to be removed from the mold. This leads to significant downtime of the overall injection molding device.

Alternatively, load cells arranged outside the mold can be used. The disadvantage of this arrangement is that e.g. sheer stresses, which are caused by the melt streaming downward along a shaft of a needle, which tend to lift of the needle from the sensor, cannot be measured and falsify the measurement.

Desired is therefore a way to measure in particular the actual forces applied to the needle, as close as possible to the tip of the needle without alterations to the cavity. It is desired to be able to determine both, shear stresses applied to the front section of the needle during the injection of the melt and the stresses applied by the melt pressing against the tip of the needle once the cavity is filled. Therefore a load cell is preferred, which is able to measure both, tension and compression forces in an axial direction of the needle as close as possible to the needle tip.

One objective of the present disclosure can be seen in providing an injection mold for monitoring forces within the mold and applied upon the needle without a sensor in the cavity.

In a preferred variation, the present disclosure relates to an injection mold comprising a first mold half and a second mold half. Typically, a cavity plate forms part of each of the first respectively the second mold half comprising at least one cavity for receiving in a closed position of the injection mold liquefied material. Depending on the design of the injection mold, the second mold half can be arranged or form part of a central mold part. The central mold part can be arranged in a rotational manner about a rotational axis. The rotational axis can be perpendicular to the axial direction.

For injecting liquefied material, the first mold half (hot side of the mold) comprises at least one hot runner nozzle with a needle arranged in a housing of the hot runner nozzle. The hot runner nozzle can comprise a nozzle housing extending along an axial direction in which the needle is arranged, displaceable along the axial direction. The nozzle housing is usually encompassed by a nozzle heater and can comprise at a distal end a nozzle tip, which can be terminated by a nozzle tip isolator. In variation, first mold half can comprise several hot-runner nozzles which are interconnected to each other by a common melt channel.

The needle is typically arranged within the hot runner nozzle and actuated by an actuator in an axial direction of the hot runner nozzle. The needle can be moved by the actuator between a closed position and an open position or any position between the open and closed position. An open position is thereby a position in which melt can flow through a gate opening at the front tip of the hot runner nozzle into the cavity. The actuator can e.g. be a pneumatic or electrical drive. The interconnection of the needle to the actuator is preferably designed torsion-proof to prevent loosening during operation. The at least one hot runner nozzle is arranged in the first mold half facing the at least one cavity. The actuator is typically arranged behind the hot runner nozzle with respect to the at least one cavity and interconnected to the injection mold in torsion-proof manner. The hot runner nozzle and the actuator, being interconnected to each other form a hot runner nozzle assembly. In the closed position, a front section of the needle seals the at least one bore to prevent liquefied material from entering the cavity through the at least one bore of the hot runner nozzle.

To be able to monitor the injection process and in particular to monitor forces applied to the needle during different stages of the manufacturing step, the injection mold comprises a load cell interconnected to the needle as described in more detail hereinafter. Forces acting upon the needle can be distinguished as follows: The force, which acts upon the needle tip, when the mold and the needle are in a closed position, after the melt has been injected into the cavity, in particular in the holding pressure phase. Forces from shear stress resulting from melt flowing along the needle in the bore of the housing of the hot runner nozzle. Dynamic forces resulting from mass inertia during opening and closing of the needle initiated by the actuator.

In a preferred variation, the needle comprises a front section and a rear section, which are separate from and interconnected to each other by a load cell arranged in between the front section and the rear section and interconnecting them in longitudinal direction. For determining the forces acting upon the front section of the needle, the load cell comprises a transducer. As the load cell is arranged between the front section and the rear section, it is foreseen to determine during operation the overlay of forces transmitted in axial direction between the front section and the rear section of the needle. Sensors with proven measurement methods such as a strain gauge or a piezo-element can be used.

Preferably, the load cell forms part of the load path of the needle and enables the transmission of tensile and compressive forces from the front section to the rear section of the needle and vice versa. In the load cell a mechanical overload protection can be implemented to protect the transducer and/or the load cell during operation from plastic deformation, which would cause a defect of the transducer. The mechanical overload protection is changeable to be able to adjust the system for different overloads.

Compared to known set-ups with membrane sensors arranged at the actuator, which limits the use to electric drives only or a compression bar which is less robust than a membrane sensor, the herein described load cells can be added in an existing injection mold independent of the type of actuator, e.g. pneumatic or electrical.

To be able retrofit the proposed load cells to existing injection molds, an additional mold plate can be added. To be able to exchange the load cell without the need to fully disassemble the entire injection mold, the load cell is typically arranged with respect to the cavity behind the front section of the needle. The front section of the needle typically extends in the mounted position in axial direction into the hot runner nozzle, with the load cell being arranged behind and connected to the front section. To make it possible to retrofit an existing injection mold with a load cell, the load cell can be arranged in a mold plate in form of an intermediate plate that is applied in addition. The load cell can be arranged in a recess of the intermediate plate which is usually arranged between the first mold half and an actuator plate. The actuator plate receives the at least one actuator and is interconnected to the first mold half in which the front section of the needle is arranged. Such a set-up even stays operational when the injection mold is functional even if the transducer is defect.

For achieving a compact design and avoiding interfaces, which can lead to increased tolerances, the mold plate can alternatively be integrally formed with the cavity plate and/or a hot runner plate. The mold plate can comprise at least one recess, e.g. in form of a bore for housing the load cell. The load cell can be mechanically interconnected in circumferential direction to the mold plate such that it is secured in circumferential direction against rotation. Good results can be achieved when the load cell comprises a projection, e.g. in form of a pin, which engages in an indentation, e.g. in form of a notch or a groove in the recess. Alternatively, the load cell can comprise an indentation for receiving a projection of the recess. Such an anti-twist element ensures that the load cell and thereto connected front and rear section of the needle do not rotate in an unwanted manner during operation. In particular, an unwanted rotation of the front section of the needle within the bore of the hot runner nozzle and/or the rear section within the actuator can be avoided.

The load cell typically comprises a housing with a front part and a rear part, wherein the transducer is arranged in axial direction between the front part and the rear part. The transducer can be arranged in the load cell in axial direction between the front section and the rear section of the needle. Depending on the operating principle of the transducer, the transducer can be arranged at the housing and measure the deformation of the housing under load during operation. Alternatively, the transducer can be deformed by the housing under load which generates a signal. Good results can be achieved, when transducers are used which are based on an operating principle wherein an elastic deformation of the part to be monitored causes an electrical signal or wherein the elastic deformation of the transducer itself causes an electrical signal.

Given the high speed of the operation of needles in injection molding devices, mass inertia may not be neglectable under certain conditions. During the injection process, the needle is typically moved back and forth within the hot runner nozzle within fractions of a second. The diameter of conventional needles is comparatively small in respect of the length. The essentially cylindrical needles have a small moment of inertia and given the slim contour and the therefore low weight also a low mass inertia. With the objective to measure the forces of the needle during operation as close as possible to the needle tip, an additional load cell may poses challenges regarding the aspect of mass inertia. Heavy and large volume load cells are usually undesirable as they may negatively impact the dynamic behavior of the needle during the injection molding process.

Good results regarding a compromise between accuracy as well as size and weight can be achieved when the transducer is in form of a slim piezo-element. Because of its relatively small size, e.g. in form of a ring shaped piezo-element, the transducer can be arranged in the load cell in a space saving manner. The transducer in form of a piezo-element, can be arranged in a preloaded manner between the front part and the rear part of the housing. In a preferred variation, the front part is connected to the rear part by a screw connection with the transducer being clamped between the front part and the rear part. A ring shaped transducer which surrounds the screw connection between the front part and the rear part of the housing has the advantage that the diameter of the load cell in axial direction can be kept small. This is beneficial regarding the objective to keep the moment of inertia small by keeping the diameter of the front and rear section of the needle as well as the diameter of the load cell as small as possible.

A piezo element in form of a ring, which is arranged encircling the axial direction, has the advantage that it can be arranged symmetrical with respect to the axial direction and clamped between the front part and the rear part of the housing, which can be formed by sleeves, which compress the piezo-element in a predefined preloaded manner. Again, to keep the outer diameter of the housing as small as possible with regard to the outer diameter of the needle to avoid a high moment of inertia, the front part and the rear part of the housing can be in form of rotational symmetrical parts with respect to the axial direction, e.g. in form of cylindrical sleeves which are screwed together. The screw connection can be a center screw connecting the font part of the housing to the rear part and thereby holding the piezo-element in place. Good results regarding the assembly can be achieved when the housing is pre-assembled such that the preload can be calibrated outside the injection mold. The housing can be designed such that the front part comprises the second interface. This way, the pre assembled and pre calibrated load cell can be easily mounted to the injection mold, interconnecting the front section of the needle via the first interface to the rear section of the needle.

Alternatively or in addition, good results for measuring the forces applied to the needle can be achieved by using a strain gauge. The housing of the load cell designed for a strain gauge preferably comprises a thinning to which at least one strain gauge is attached to measure the deformation of the thinning during operation. The housing can be cup-shaped and encapsulate the strain gauge. The rear part of the housing can comprise a rear wall with an interface for connecting the rear section of the needle to the housing. The sidewall of the housing, which can protrude either from the rear wall of the housing or from a front wall of the housing in axial direction, typically encompasses the strain gauge and is in the mounted state connected to the front section of the needle via the second interface.

The front part or the rear part of the housing can be designed as a closure for the cup shaped housing, e.g. in form of a disc shaped cap. For connecting the housing to the front section of the needle, the second interface is typically arranged at the front part of the housing. The second interface can be arranged inside the thinning, wherein the thinning is annular shaped and arranged in radial direction, surrounding the second interface. The thinning can in radial direction extend circumferentially around the second interface and transfer the forces from the front section of the needle via the second interface to the rear section of the needle via the rear part of the housing. The thinning which is in comparison to the remaining wall parts of the housing thinner, experiences the highest degree of deformation under load. The strain gauge is arranged at the thinning to determine the applied forces based on the degree of deformation of the thinning. The thinning ensures that the deformation takes place in a controlled manner essentially in the area where the strain gauge is applied.

With the load cell being arranged within the injection mold, either within the mold in form of an intermediate plate or directly in the first mold. guiding cabling from outside the mold, e.g. from a controller to the load cell can be an issue. Especially since the load cell is typically arranged in a moving manner in axial direction, moving along with the thereto connected needle. This implies that also cabling being connected to the transducer at the load cell has to be connected to be movable. The mold plate can comprise at least one channel for guiding the cabling to the load cell.

To prevent the cabling from being overstrained due to tight bending radii, the at least one channel can extend in radial direction with respect to the load cell. To prevent sharp edges and the cabling from wearing through, the channel is preferably funnel shaped converging in the radial direction. A funnel shaped inlet of the channel provides a smooth transition for the cabling. Good results regarding the cabling can be achieved when the cabling is in form of a trailing cable. Trailing cables are usually well insulated and protected with either galvanized steel wire armoring, extra stout braiding hosepipe, or other material.

To be able to exchange the load cell without the need to remove the needle from the hot runner nozzle or the actuator, the front section of the needle can comprise at a rear end a first interface by which during operation the front section of the needle is interconnected to a second interface arranged at a front end of the load cell. Such a design of the needle makes it possible to replace or retrofit the load cell without extracting the needle from the hot runner nozzle. Alternatively or in addition, the rear section of the needle can comprise a third interface by which the rear section of the needle is interconnectable to a fourth interface of the actuator. This allows to replace or retrofit the load cell without separating the rear section of the needle from the actuator.

The first interface can be with respect to the second interface locked with a screw and/or clamp connection. The third interface can be locked with respect to the fourth interface by a screw connection and/or clamp connection, which is accessible from the rear end of the actuator. This makes it possible that the connection between the third and the fourth interface can be loosened and the actuator and/or the actuator plate can be removed without affecting the mounted needle and/or load cell. In a variation, the first interface of the front section of the needle is compatible to the fourth interface of the actuator. This makes it possible that the load cell can be removed from an existing injection mold, in particular with mounted intermediate plate, without the need to remove the front section of the needle and/or the intermediate plate. An adapter or alternatively a longer, e.g. single pieced needle can be mounted to the injection mold, wherein the first interface at the rear end of the needle is interconnected to the fourth interface of the actuator.

The actuator is typically either electric or pneumatic. Typically, pneumatic cylinders are used for moving the needle within the hot runner nozzle in axial direction. The actuator can comprise a fourth interface for connecting the rear section of the needle. The fourth interface can be a bushing, which extends across the actuator. In the mounted position, the third interface of the rear section of the needle can be arranged in the bushing. The rear section of the needle typically is an essentially cylindrical shaft, which extends from the rear end of the load cell through the actuator to the rear end of the actuator.

The hot runner nozzle assembly, comprising the front and rear section of the needle, a load cell and an actuator is typically connected via screw connections. In a variation, the front section of the needle is screwed to the front part of the housing with the first interface being a thread that is attached to the housing via a nut. Similarly also the third interface of the rear part of the needle can be connected to the actuator by a screw connection. To be able to connect the load cell to the front section of the needle while the front section is already mounted in the hot runner nozzle, the front section needs to be prevented from rotating in an unwanted manner. Similarly also the rear section of the needle needs to be connected to the actuator without applying high torque to the already mounted load cell. The third interface may comprise a recess, e.g. in form of a hexagon socket for securing the third interface against rotation during interconnection.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims. The drawings are showing:

FIG. 1 A first variation of the injection mold in a perspective view from behind and above with a broken out section;

FIG. 2 The variation of the injection mold according to FIG. 1 in an exploded perspective view from behind and above with a broken out section;

FIG. 3 A first variation of the hot runner nozzle assembly in an exploded perspective view from behind and above with a broken out section;

FIG. 4 The variation of the hot runner nozzle assembly according to FIG. 3 in an exploded perspective view from behind and above with a broken out section;

FIG. 5 A first variation of the load cell in an exploded perspective view from behind and above with a broken out section;

FIG. 6 A second variation of the hot runner nozzle assembly in an exploded perspective view from behind and above with a broken out section;

FIG. 7 The variation of the hot runner nozzle assembly according to FIG. 6 in an exploded perspective view from behind and above with a broken out section;

FIG. 8 A second variation of the load cell in an exploded perspective view from behind and above with a broken out section.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

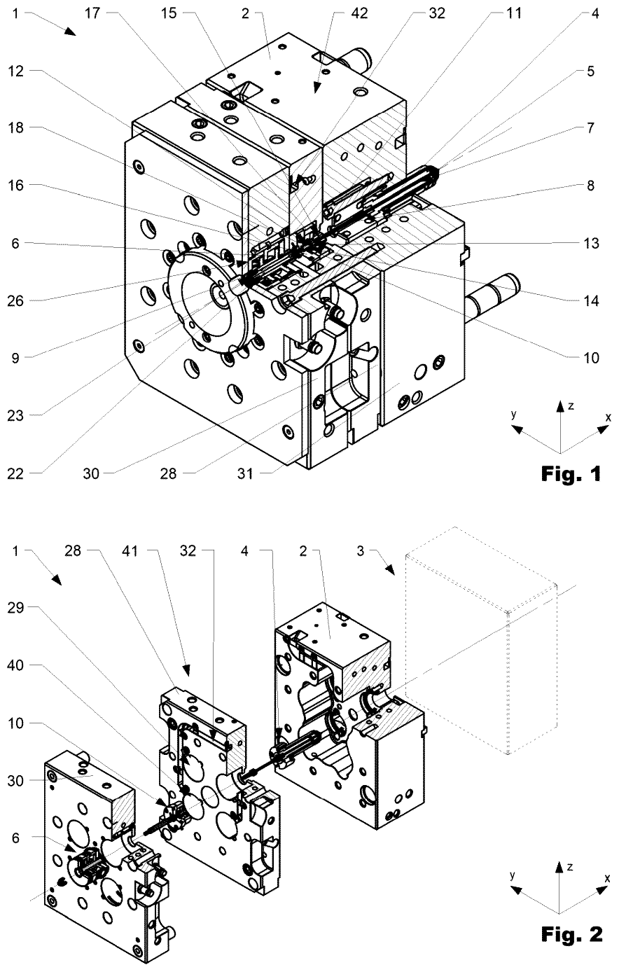

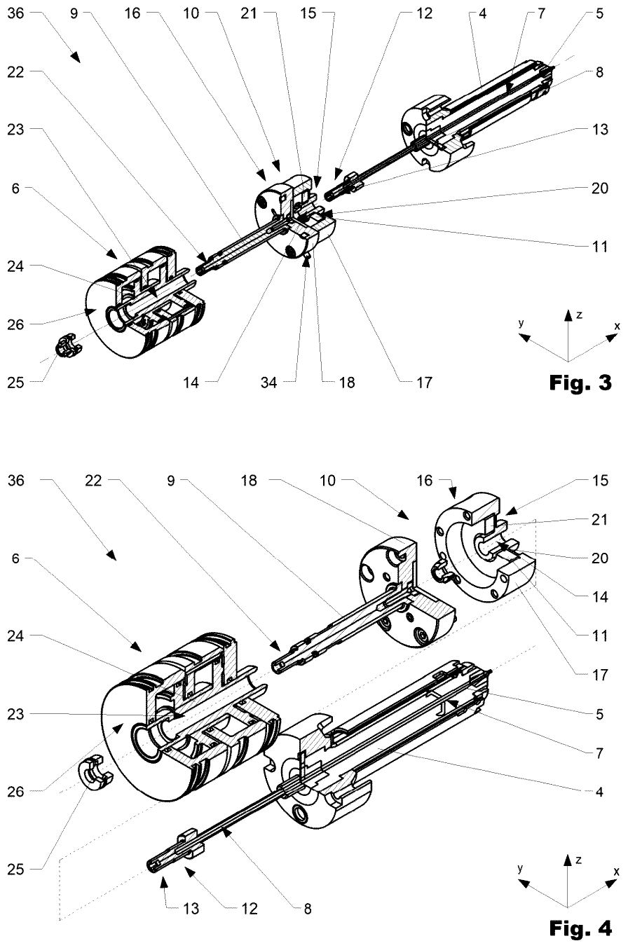

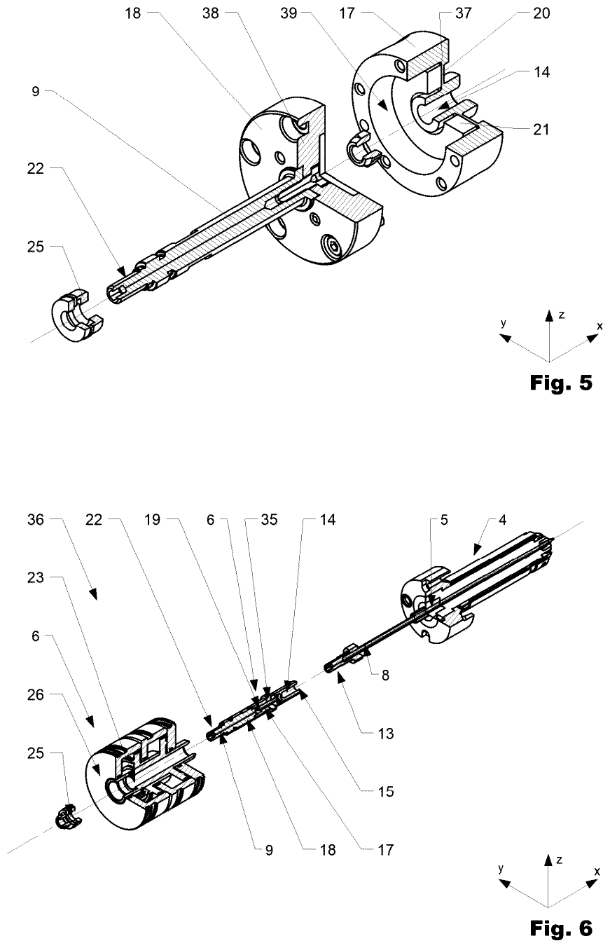

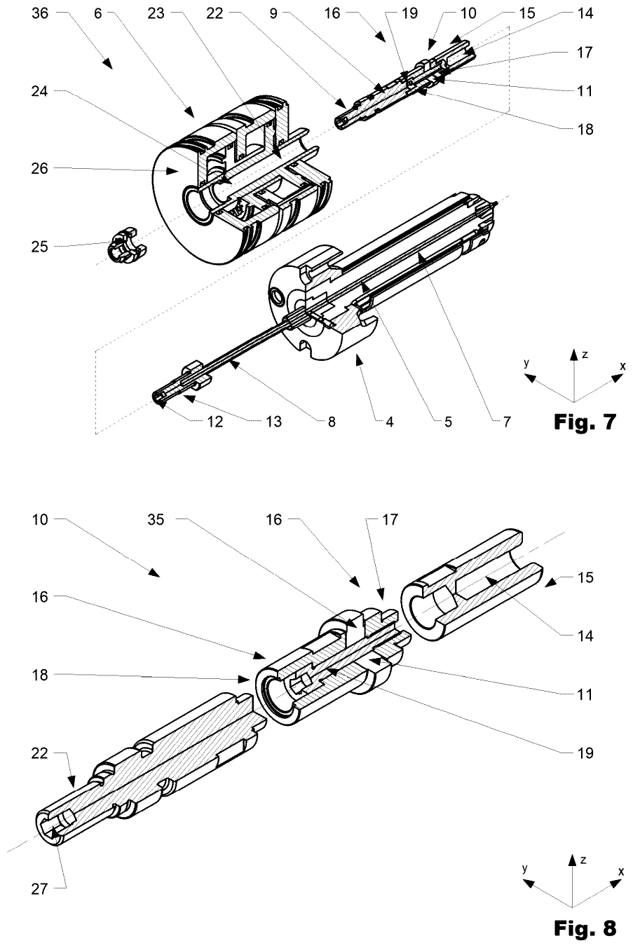

FIG. 1 shows a first variation of the injection mold 1 in a perspective view from behind and above with a broken out section. FIG. 2 shows the variation of the injection mold 1 according to FIG. 1 in an exploded perspective view from behind and above with a broken out section. FIG. 3 shows a first variation of the hot runner nozzle assembly 36 in an exploded perspective view from behind and above with a broken out section. FIG. 4 shows the variation of the hot runner nozzle assembly 36 according to FIG. 3 in an exploded perspective view from behind and above with a broken out section. FIG. 5 shows a first variation of the load cell 10 in an exploded perspective view from behind and above with a broken out section. FIG. 6 shows a second variation of the hot runner nozzle assembly 36 in an exploded perspective view from behind and above with a broken out section. FIG. 7 shows the variation of the hot runner nozzle assembly 36 according to FIG. 6 in an exploded perspective view from behind and above with a broken out section. FIG. 8 shows a second variation of the load cell 10 in an exploded perspective view from behind and above with a broken out section.

FIG. 1 shows a variation of the injection mold 1 comprising a first mold half 2 and a second mold half 3. A cavity plate can be attached to the first mold half (not shown). For injecting liquefied material, the first mold half 2 comprises at least one hot runner nozzle 4 with a needle 5. The needle 5 is arranged within a bore 7 of the hot runner nozzle 4. The shown needle 4 is actuated by an actuator 6 in an axial direction of the needle 5, between a closed position and an open position or any position between the open and closed position. The hot runner nozzle 4, load cell 10 and thereto interconnected actuator 6 form a hot runner nozzle assembly 36. The shown hot runner nozzle assembly 36 is arranged along an axial direction. The shown load cell 10 is arranged in a recess 29 of a mold plate 28.

For achieving a compact design and avoiding interfaces, which lead to increased tolerances, the mold plate 28 can alternatively be integrally formed with the cavity plate and/or a hot runner plate. The shown mold plate 28 comprises at least one recess 29 for housing the load cell 10. The shown load cell 10 is mechanically interconnected in circumferential direction to the mold plate 28 such that it is secured in circumferential direction against rotation. Good results can be achieved when the load cell 10 comprises a projection 34, e.g. in form of a pin, which engages in an indentation, e.g. in form of a notch or a groove in the recess 29. Alternatively, the load cell 10 can comprise an indentation for receiving a projection of the recess. Such an anti-twist element ensures that the load cell 10 and thereto connected front section 8 and rear section 9 of the needle 5 do not rotate in an unwanted manner during operation. In particular, an unwanted rotation of the front section 8 of the needle 5 within the bore 7 of the hot runner nozzle 4 and/or the rear section 9 within the actuator 6 can be avoided.

FIG. 2 shows the injection mold 1 in an exploded view, wherein the load cell 10 is arranged with respect to the cavity behind the hot runner nozzle 4. The front section 8 of the needle 5 extends in the mounted position in axial direction into the hot runner nozzle 4, with the load cell 10 being arranged behind and connected to the front section 8 of the needle 5. The shown hot runner nozzle assembly 36 can be also retrofit to existing injection molds 1 by adding the shown mold plate 28 in form of an intermediate plate between the first mold half 2 and the actuator plate 30. The shown load cell 10 is arranged in a recess 29 of the intermediate plate. The shown actuator plate 30 receives the at least one actuator 6 and is interconnected to the first mold half 2 in which the front section 8 of the needle 5 is arranged.

To guide cabling 40 from outside the injection mold 1, e.g. from a controller to the load cell 10, with the load cell 10 being arranged within the injection mold 1 in the recess 29 of the mold plate 28, the mold plate 28 comprises at least one channel 32. To prevent the cabling 40 from being overstrained due to tight bending radii, the at least one channel 32 extends in radial direction with respect to the load cell 10 away from the recess 29. To prevent sharp edges and the cabling 40 from wearing through, the shown channel 32 is funnel shaped and converges in the radial direction. A funnel shaped inlet into the channel 32 provides a smooth transition for the cabling 40. Good results regarding the cabling 40 can be achieved when the cabling 40 is in form of a trailing cable. Trailing cables are usually well insulated and protected with either galvanized steel wire armoring, extra stout braiding hosepipe, or other material.

The actuator 6 is typically either electric or pneumatic. The shown actuator in form of a pneumatic cylinder moves the needle 5 within the hot runner nozzle 4 in axial direction. The actuator 6 comprises a fourth interface 23 for connecting the actuator 6 to the rear section 9 of the needle 5. The shown fourth interface 23 is a bushing 24, which extends in axial direction across the actuator 6. In the mounted position the third interface 22 of the rear section 9 of the needle 5 is arranged in the bushing 24. The rear section 9 of the needle 5 is an essentially cylindrical shaft, which extends from the rear end of the load cell 10 through the actuator 6 to the rear end 26 of the actuator 6.

The front section 8 of the needle 5 is screwed to the front part 17 of the housing 16 with the first interface 13 being a thread that is attached to the housing 16 via a nut. Similarly, also the third interface 22 of the rear part 18 of the needle 5 can be connected to the actuator 6 by a screw connection. To be able to connect the load cell 10 to the front section 8 of the needle 5 while the front section 8 is already mounted in the hot runner nozzle 4, the front section 8 needs to be prevented from rotating in an unwanted manner. Similarly also the rear section 9 of the needle 5 needs to be connected to the actuator 6 without applying high torque to the already mounted load cell 10. The third interface 22 therefore comprises a recess 27, e.g. in form of a hexagon socket for securing the third interface 22 against rotation during interconnection.

FIGS. 3 to 8 show a first and a second variation of the hot runner nozzle assembly 36, comprising the front section 8 and rear section 9 of the needle 5, a load cell 10 and an actuator 6 being interconnected to each other via screw connections. FIGS. 3 to 5 show a first variation of the hot runner nozzle assembly 36 comprising a load cell 10 with a transducer 11 in form of a strain gauge 21. For measuring the forces applied to the needle 5, the strain gauge 21 is arranged inside the housing 16 of the load cell 10. The housing 16 of the load cell 10 is designed for a strain gauge 21 comprising a thinning 20 to which the at least one strain gauge 21 is attached to measure the deformation of the thinning 20 during operation.

As can be obtained best from FIG. 4, the shown housing 16 is cup-shaped and encapsulates the strain gauge 21. The rear part 18 of the housing 16 is designed as a disk shaped rear wall 38 with an interface for connecting the rear section 9 of the needle 5 to the housing 16. The sidewall of the housing 16, which can protrude from the rear wall 38 and/or the front wall 37 forms an installation space 39 in the housing 16 in axial direction, encompassing the transducer 11. The sidewall is in the mounted state connected to the front wall 37 and rear wall 38 of the housing 16. The front wall 37 and/or the rear wall 38 of the housing 16 can be designed as a closure for the cup shaped housing 16, e.g. in form of a disc shaped cap.

As can be obtained best from FIG. 5, for connecting the housing 16 to the front section 8 of the needle 5, the second interface 14 is typically arranged at the front part 17 of the housing 16. The shown second interface 14 is arranged inside the thinning 20, wherein the thinning 20 is annular shaped and arranged in radial direction. The thinning 20 can in radial direction extend circumferentially around the second interface 14 and transfer the forces from the front section 8 of the needle 5 to the rear section 9 of the needle 5 via the rear part 18 of the housing 16. The thinning 20, which is in comparison to the remaining wall parts of the housing 16 thinner, experiences the highest degree of deformation under load. The strain gauge 21 is arranged at the thinning 20 to determine the applied forces based on the degree of deformation. The thinning 20 ensures that the deformation takes place in a controlled manner essentially in the area of the thinning 20.

FIGS. 6 to 8 show a second variation of the hot runner nozzle assembly 36. The shown needle 5 also comprises a front section 8 and a rear section 9, which are separate from each other and interconnected to each other by the load cell 10. For measuring forces applied to the needle 5, the load cell 10 of the shown variation comprises a transducer 11 in form of a piezo-element, to determine during operation the force transmitted in axial direction between the front section 8 and the rear section 9 of the needle 5. In addition, also the load cell 10 of the second variation transmits forces between the front section 8 of the needle 5 and the rear section 9 of the needle 5. The shown load cell 10 is part of the load path of the needle 5 and enables the transmission of tensile and compressive forces from the front section 8 to the rear section 9 and vice versa.

As can be obtained best from FIG. 6, also the load cell of the second variation of the hot runner nozzle assembly 36 comprises a housing 16 with a front part 17 and a rear part 18, wherein the transducer 11 is arranged in axial direction between the front part 17 and the rear part 18. The transducer 11 is arranged in the load cell 10 in axial direction between the front section 8 and the rear section 9 of the needle 5. The shown variation of the load cell has a comparatively small silhouette with an outer diameter of the load cell 10 being not substantially larger than the outer diameter of the needle 5. As can be obtained best from FIG. 7, the piezo element 35 is in form of a ring. The ring shaped piezo-element 35 is arranged encircling the axial direction, which has the advantage that it can be arranged symmetrical with respect to the axial direction and clamped between the front part 17 and the rear part 18 of the housing 16, which are formed by sleeves, which compress the piezo-element 35 in a pre-defined preloaded manner.

To keep the outer dimeter of the housing 16 as small as possible with regard to the outer diameter of the needle 5 to avoid a high moment of inertia, the front part 17 and the rear part 18 of the housing 16 of the shown variation are in form of rotational symmetrical parts with respect to the axial direction, e.g. in form of cylindrical sleeves which are screwed together. The shown screw connection 19 is a center screw, connecting the font part 17 of the housing 16 to the rear part 18 and thereby holding the piezo-element 35 in place. Good results regarding the assembly can be achieved when the housing 16 is pre-assembled such that the preload can be calibrated outside the injection mold 1. The front part 17 of the shown housing 16 comprises the second interface 14 and at the rear part 18 an interface for connecting the housing 16 to the rear section 9 of the needle 5.

As can be obtained best from FIG. 8, the ring shaped piezo-element 35 is arranged in the load cell 10, preloaded between the front part 17 and the rear part 18. The transducer 11, e.g. in form of a piezo-element 35. In the shown variation, the front part 17 is connected to the rear part 18 by a screw connection 19 with the transducer 11 being clamped between the front part 17 and the rear part 18. The ring shaped transducer 11 which surrounds the screw connection 19 arranged between the front part 17 and the rear part 18 of the housing 16 has the advantage that the diameter of the load cell 10 in axial direction can be kept small. The objective with regard to the moment of inertia is to keep the diameter of the front section 8 and rear section 9 of the needle 5 as well as the diameter of the load cell 10 as small as possible.

As can be obtained best from FIGS. 4 and 7 the first interface 13 of both variations is with respect to the second interface 14 locked with a screw and/or clamp connection 25. The third interface 22 is locked with respect to the fourth interface 23 by a screw connection and/or clamp connection 25, which is accessible from the rear end 26 of the actuator 6. This makes it possible that the connection between the third interface 22 and the fourth interface 23 can be loosened and the actuator 6 and/or the actuator plate 30 can be removed without affecting the mounted needle 5 and/or load cell 10. In both variations, the first interface 13 of the front section 8 of the needle 5 is compatible to the fourth interface 23 of the actuator 6. This makes it possible that the load cell 10 can be removed from an existing injection mold 1, in particular with mounted intermediate mold plate 28, without the need to remove the front section 8 of the needle 5 and/or the intermediate plate 28. An adapter or alternatively a longer, e.g. single pieced, needle 5 can be mounted to the injection mold 1, wherein the first interface 13 at the rear end 12 of the needle 5 is interconnected to the fourth interface 23 of the actuator 6.

To be able to exchange the load cell 10 without the need to remove the needle 5 form the hot runner nozzle 4 or the actuator 6, the front section 8 of the needle 5 of both variations comprises at the rear end 12 a first interface 13 by which during operation the front section 8 of the needle 5 is interconnected to a second interface 14 arranged at the front wall 37 of the load cell 10. Such a design of the needle 5 makes it possible to replace or retrofit the load cell 10 without extracting the needle 5 from the hot runner nozzle 4. Alternatively or in addition, the rear section 9 of the needle 5 can comprise a third interface 22 by which the rear section 9 of the needle 5 is interconnectable to a fourth interface 23 of the actuator 6. This allows to replace or retrofit the load cell 10 without separating the rear section 9 of the needle 5 from the actuator 6.

Rather, the words used in the specification are words of description rather than limitation, and it is understood that various changes may be made without departing from the Spirit and scope of the disclosure.

LIST OF DESIGNATIONS

| | |
|---|---|
| 1 | Injection mold |
| 2 | First mold half |
| 3 | Second mold half |
| 4 | Hot runner nozzle |
| 5 | Needle |
| 6 | Actuator |
| 7 | Bore |
| 8 | Front section (Needle) |
| 9 | Rear section (Needle) |
| 10 | Load cell |
| 11 | Transducer |
| 12 | Rear end (Front section) |
| 13 | First interface |
| 14 | Second interface |
| 15 | Front end (Load cell) |
| 16 | Housing |
| 17 | Front part (Housing) |
| 18 | Rear part (Housing) |
| 19 | Screw connection (load cell) |
| 20 | Thinning |
| 21 | Strain gauge |
| 22 | Third interface |
| 23 | Fourth interface |
| 24 | Bushing |
| 25 | Connection (third interface) |
| 26 | Rear end (Actuator) |
| 27 | Recess (Third interface) |
| 28 | Mold plate |
| 29 | Recess (Mold plate) |
| 30 | Actuator plate |
| 31 | Cavity plate |
| 32 | Channel |
| 33 | Position sensor |
| 34 | Projection |
| 35 | Piezo element |
| 36 | Hot runner nozzle assembly |
| 37 | Front wall (Housing) |
| 38 | Rear wall (Housing) |
| 39 | Installation space |
| 40 | Cabling |
| 41 | Intermediate plate |
| 42 | Hot-runner plate |

1. An injection mold comprising a first mold half and a second mold half, wherein the first mold half comprises
a. at least one hot runner nozzle with a needle and an actuator for actuating the needle in the hot runner nozzle in axial direction-between a closed position and an open position, wherein
b. the needle comprises a front section and a rear section interconnected to each other by a load cell for transmitting forces between the front section and the rear section wherein
c. the load cell comprises a transducer to determine during operation the forces transmitted in axial direction between the front section and the rear section.

2. The injection mold according to claim 1, wherein the front section of the needle comprises at a rear end a first interface by which during operation it is interconnected to a second interface arranged at a front end of the load cell.

3. The injection mold according to claim 1, wherein the transducer is arranged in the load cell in axial direction between the front section and the rear section of the needle.

4. The injection mold according to claim 1, wherein the load cell comprises a housing with a front part and a rear part and wherein the transducer is arranged in axial direction between the front part and the rear part.

5. The injection mold according to claim 4, wherein the transducer is arranged in a preloaded manner between the front part and the rear part of the housing.

6. The injection mold according to claim 4, wherein the front part is connected to the rear part by a screw connection with the transducer being clamped between the front part and the rear part.

7. The injection mold according to claim 6, wherein the transducer is ring shaped and surrounds the screw connection between the front part and the rear part of the housing.

8. The injection mold according to claim 1, wherein the transducer is a piezo-element.

9. The injection mold 4 according to claim 4, wherein the housing comprises a thinning to which at least one strain gauge is attached to measure the deformation of the thinning during operation.

10. The injection mold according to claim 9, wherein the thinning is annular shaped.

11. The injection mold according to claim 1, wherein the rear section of the needle comprises a third interface by which it is interconnectable to a fourth interface of the actuator.

12. The injection mold according to claim 11, wherein the fourth interface is a bushing which extends across the actuator and in which in the mounted position the third interface is arranged.

13. The injection mold according to claim 11, wherein the third interface is locked with respect to the fourth interface by a screw connection and/or clamp connection which is accessible from the rear end of the actuator.

14. The injection mold according to claim 11, wherein the third interface comprise a recess for securing the third interface against rotation during interconnection.

15. The injection mold according to claim 1, wherein the load cell is arranged in a mold plate inside a recess, with
a. the mold plate being an intermediate plate arranged between an actuator plate in which at least one actuator is arranged and a cavity plate in which at least one cavity is arranged, or
b. the mold plate is the cavity plate and/or a hot runner plate.

16. The injection mold according to claim 15, wherein the load cell is mechanically interconnected in circumferential direction to the mold plate such that it is secured in circumferential direction against rotation.

17. The injection mold according to claim 15, wherein the mold plate comprises at least one channel for guiding cabling to the load cell, wherein the at least one channel extends in radial direction with respect to the load cell and is funnel shaped converging in the radial direction.
